(19) United States
(12) Patent Application Publication
(10) Pub. No.: US 2008/0111491 A1
(43) Pub. Date: May 15, 2008

(54) RADIO-FREQUENCY LIGHTING CONTROL SYSTEM

(76) Inventor: Joel S. Spira, Coopersburg, PA (US)

Correspondence Address: OSTROLENK FABER GERB & SOFFEN, 1180 AVENUE OF THE AMERICAS, NEW YORK, NY, 100368403, US

(21) Appl. No.: 11/559,166

(22) Filed: Nov. 13, 2006

(51) Int. Cl. H05B 39/04; H05B 39/02

(52) U.S. Cl. 315/158

(57) ABSTRACT

A wireless lighting control system comprises a dimmer switch and a remote control. The dimmer switch is coupled in series between an AC power source and a lighting load and comprises a first actuator and a wireless receiver. The dimmer switch is operable to control the amount of power delivered to the lighting load in response to an actuation of the first actuator or a wireless control signal received by the wireless receiver. The remote control comprises a second actuator and a wireless transmitter operable to transmit the wireless control signal is response to an actuation of the second actuator. The remote control is operable to be associated with the dimmer switch in response to simultaneous actuations of the first and second actuators. Accordingly, the dimmer switch subsequently controls the intensity of the lighting load in response to the wireless control signal transmitted by the remote control.

### BACKGROUND OF THE INVENTION

1. Field of the Invention

The present invention relates to a wireless lighting control system for controlling the amount of power delivered to an electrical load from a source of alternating-current (AC) power, and more particularly, to a simple radio-frequency (RF) lighting control system providing an easy association between a remote control and a dimmer switch.

2. Description of the Related Art

Control systems for controlling electrical loads, such as lights, motorized window treatments, and fans, are known. Such control systems often use radio-frequency (RF) transmission to provide wireless communication between the control devices of the system. One example of an RF lighting control system is disclosed in commonly-assigned U.S. Pat. No. 5,905,442, issued on May 18, 1999, entitled METHOD AND APPARATUS FOR CONTROLLING AND DETERMINING THE STATUS OF ELECTRICAL DEVICES FROM REMOTE LOCATIONS, the entire disclosure of which is hereby incorporated by reference.

The RF lighting control system of the '442 patent includes wall-mounted load control devices, table-top and wall-mounted master controls, and signal repeaters. The control devices of the RF lighting control system include RF antennas adapted to transmit and receive the RF signals that provide for communication between the control devices of the lighting control system. All of the control devices transmit and receive the RF signals on the same frequency. Each of the load control devices includes a user interface and an integral dimmer circuit for controlling the intensity of an attached lighting load. The user interface has a pushbutton actuator for providing on/off control of the attached lighting load and a raise/lower actuator for adjusting the intensity of the attached lighting load. The table-top and wall-mounted master controls each have a plurality of buttons and are operable to transmit RF signals to the load control devices to control the intensities of the lighting loads. The signal repeaters initiate configuration procedures for the RF lighting control system and help to ensure error-free communication by repeating the RF signals to ensure that every device of the system reliably receives the RF signals.

To prevent interference with other nearby RF lighting control systems located in close proximity, the RF lighting control system of the '442 patent preferably uses a house code (i.e., a house address), which each of the control devices stores in memory. Each of the control devices of the lighting control system is also assigned a unique device address (typically one byte in length) for use during normal system operation to avoid collisions between transmitted RF communication signals. The RF lighting control system requires elaborate setup and configuration procedures at the time of installation to assign the house code and the device addresses to each of the control devices in the system. Further, the RF lighting control system requires a signal repeater functioning as a central controller to be a part of the system during setup.

Thus, there is a need for a simple RF lighting control system that does not require a central controller and can be easily setup by a user at the time of installation.

### SUMMARY OF THE INVENTION

According to the present invention, a lighting control system comprises a remotely-controllable load control device and a remove transmitting device. The remotely-controllable load control device is adapted to be disposed in an electrical wall-box and connectable to an electrical power system for providing electrical power to an electrical load. The remotely controllable load control device comprises a controllably conductive device for switching electrical power to the load; a first controller for controlling a conducting state of the controllably conductive device; a first actuator coupled to the first controller; and a wireless signal receiver coupled to the first controller for providing a first control signal to the controller. The first controller controls the controllably conductive device in response to one of the first control signal and an actuation of the first actuator. The remote transmitting device is operable to transmit a wireless control signal to the wireless signal receiver for controlling the supply of electrical power to the load from a remote location. The remote transmitting device comprises a second controller, a second actuator coupled to the second controller, and a wireless signal transmitter coupled to the second controller. The second controller is operable to generate the wireless control signal, which includes a unique identifier that uniquely identifies the remote transmitting device. The wireless signal transmitter is operable to transmit the wireless control signal to the first controller of the remotely-controllable load control device in response to an actuation of the second actuator. The remotely-controllable load control device is operable to associate the identifier includes in the wireless control signal with the remotely-controllable load control device in response to simultaneous actuations of the first and second actuators for a predetermined amount of time, thereby to enable control of the controllably conductive device from the remote transmitting device.

According to a second embodiment of the present invention, a wireless lighting control system for controlling the amount of power delivered to an electrical load from an AC power source comprises a load control device and a remote control. The load control device is operable to be coupled in series electrical connection between the source and the load for controlling the amount of power delivered to the load. The load control device comprises a first actuator and a wireless receiver. The load control device is operable to control the amount of power delivered to the load in response to an actuation of the first actuator and a wireless control signal received by the wireless receiver. The remote control comprises a second actuator and a wireless transmitter. The wireless transmitter is operable to transmit the wireless control signal in response to an actuation of the second actuator. The remote control is associated with the load control device in response to simultaneous actuations of the first and second actuators, such that the load control device is operable to control the amount of power delivered to the load in response to the wireless control signal transmitted by the wireless transmitter of the remote control.

In addition, the present invention further provides a load control device for controlling the amount of power delivered to an electrical load from an AC power source. The load control device comprises a controllably conductive device, a controller, an actuator, a wireless receiver, and a memory. The controllably conductive device is operable to be coupled in series electrical connection between the source and the load for controlling the amount of power delivered to the load. The controllably conductive device has a control input for controlling the controllably conductive device between a conductive state and a non-conductive state. The controller is coupled to the control input for controlling the controllably conductive device. The actuator coupled to the controller, such that the controller is operable to detect that the actuator has been actuated for a predetermined amount of time. The wireless receiver coupled to the controller and operable to receive a wireless control signal from a remote control. The wireless control signal comprises a unique identifier associated with the remote control. The memory is coupled to the controller. The controller is operable to store the unique identifier in the memory when the controller has detected that the actuator has been actuated for the predetermined amount of time.

Further, the present invention provides a method of controlling a dimmer switch from a remote control in a wireless lighting control system. The dimmer switch is operable to control the amount of power delivered to an electrical load from an AC power source. The method comprises the steps of simultaneously actuating a first actuator on the dimmer switch and a second actuator on the remote control for a predetermined amount of time, and storing a serial number associated with the remote control at the dimmer switch to associate the remote control with the dimmer switch.

According to yet another aspect of the present invention, a method of associating a remote control with a dimmer switch in a wireless lighting control system comprises the steps of simultaneously actuating a first actuator on the dimmer switch and a second actuator on the remote control for a predetermined amount of time, and storing a serial number of the remote control at the dimmer switch in response to the step of simultaneously actuating.

Other features and advantages of the present invention will become apparent from the following description of the invention that refers to the accompanying drawings.

### BRIEF DESCRIPTION OF THE DRAWINGS

FIG. 1 is a simple diagram of an RF lighting control system according to the present invention;

FIG. 2A is a simplified block diagram of the dimmer switch of the RF lighting control system of FIG. 1;

FIG. 2B is a simplified block diagram of the remote control of the RF lighting control system of FIG. 1;

FIG. 3 is a flowchart of a button procedure executed by the controller of the remote control of FIG. 2B;

FIG. 4 is a flowchart of an RF signal procedure executed by the controller of the dimmer switch of FIG. 2A; and

FIG. 5 is a flowchart of an association procedure executed by the controller of the dimmer switch of FIG. 2A.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

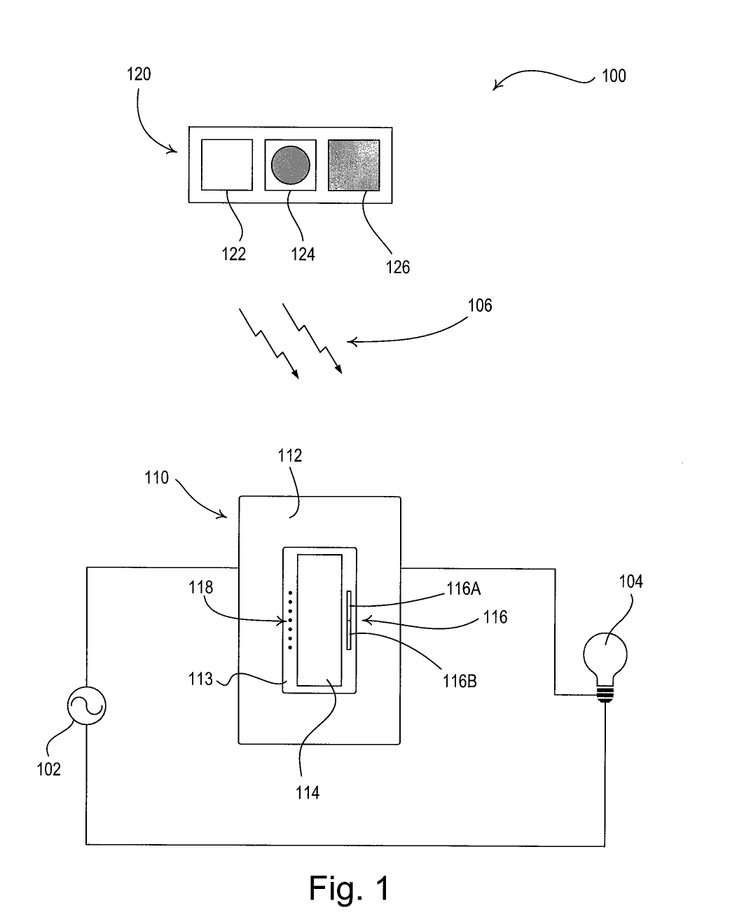

FIG. 1 is a simple diagram of an RF lighting control system 100 according to the present invention. The lighting control system 100 comprises a remotely-controllable load control device, i.e., a dimmer switch 110, and a remote control 120. Preferably, the dimmer switch 110 is adapted to be wall-mounted in a standard electrical wallbox. The dimmer switch 110 is operable to be coupled in series electrical connection between an AC power source 102 and an electrical lighting load 104 for controlling the amount of power delivered to the lighting load. The dimmer switch 110 comprises a faceplate 112 and a bezel 113 received in an opening of the faceplate. The dimmer switch 110 further comprises a toggle actuator 114, i.e., a button, and an intensity adjustment actuator 116. Actuations of the toggle actuator 114 toggle, i.e., alternately turn off and on, the lighting load 104. Actuations of an upper portion 116A or a lower portion 116B of the intensity adjustment actuator 116 respectively increase or decrease the amount of power delivered to the lighting load 104 and thus increase or decrease the intensity of the lighting load 104. A plurality of status indicators 118, e.g., light-emitting diodes (LEDs), are arranged in a linear array on the left side of the bezel 113. The status indicators 118 are illuminated to provide feedback of the intensity of the lighting load 104. An example of a dimmer switch having a toggle actuator 114 and an intensity adjustment actuator 116 is described in greater detail in U.S. Pat. No. 5,248,919, issued Sep. 29, 1993, entitled LIGHTING CONTROL DEVICE, the entire disclosure of which is hereby incorporated by reference.

The remote control 120 comprises a plurality of actuators: an on button 122, a preset button 124, and an off button 126. The remote control 120 transmits messages via RF signals 106 to the dimmer switch 110 in response to actuations of the on button 122, the preset button 124, and the off button 126. Preferably, a message transmitted by the remote control 120 includes a serial number associated with the remote control and a command (e.g., on, off, or preset). During a setup procedure of the RF lighting control system 100, the dimmer switch 110 is associated with one or more remote controls 120. The dimmer switch 110 is then responsive to messages containing the serial number of the remote control 120 to which the dimmer switch is associated. The dimmer switch 110 is operable to turn on and to turn off the lighting load 104 in response to an actuation of the on button 122 and the off button 126, respectively. The dimmer switch 110 is operable to control the lighting load 104 to a preset intensity level in response to an actuation of the preset button 124.

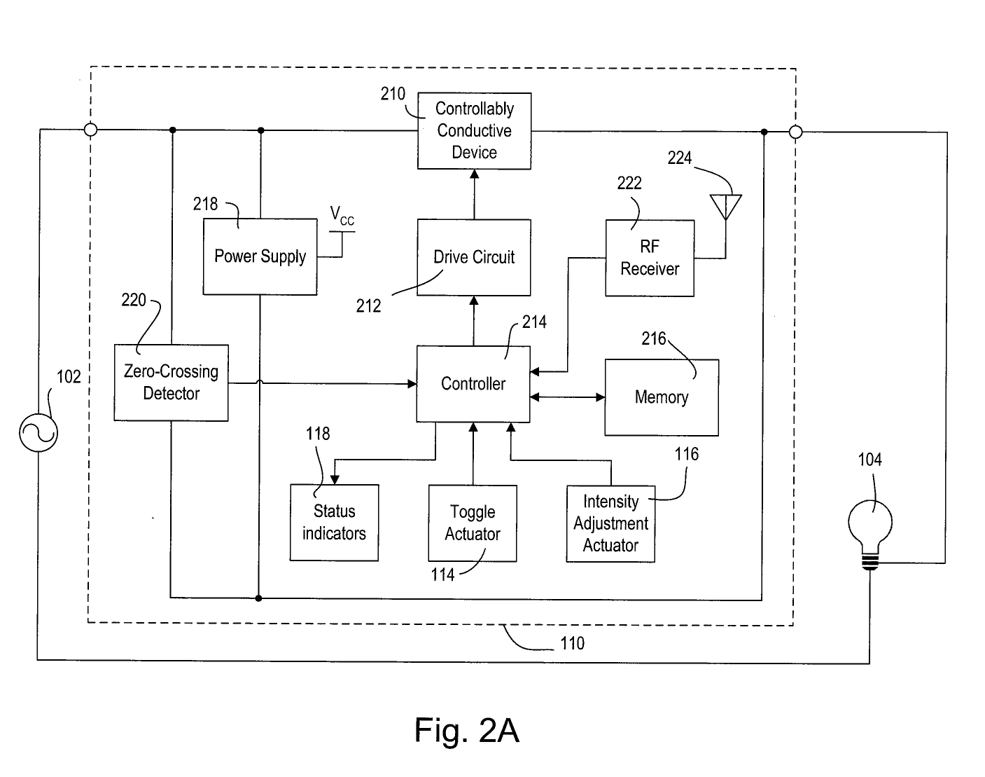

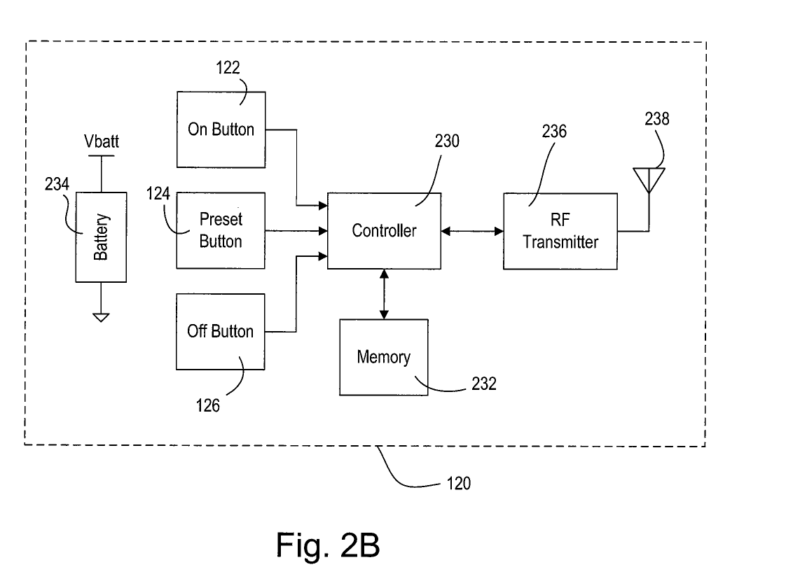

FIG. 2A is a simplified block diagram of the dimmer switch 110. The dimmer switch 110 comprises a controllably conductive device 210 coupled in series electrical connection between the AC power source 102 and the lighting load 104 for control of the power delivered to the lighting load. The controllably conductive device 210 may comprise any suitable type of bidirectional switch, such as, for example, a triac, a field-effect transistor (FET) in a rectifier bridge, or two FETs in anti-series connection. The controllably conductive device 210 includes a control input coupled to a drive circuit 212. The input to the control input will render the controllably conductive device 210 conductive or non-conductive, which in turn controls the power supplied to the lighting load 204.

The drive circuit 212 provides control inputs to the controllably conductive device 210 in response to command signals from a controller 214. The controller 214 is preferably implemented as a microcontroller, but may be any suitable processing device, such as a programmable logic device (PLD), a microprocessor, or an application specific integrated circuit (ASIC). The controller 214 receives inputs from the toggle actuator 114 and the intensity adjustment actuator 116 and controls the status indicators 118. The controller 214 is also coupled to a memory 216 for storage of the preset intensity of lighting load 104 and the serial number of the remote control 120 to which the dimmer switch 110 is associated. A power supply 218 generates a direct-current (DC) voltage V_{CC} for powering the controller 214, the memory 216, and other low-voltage circuitry of the dimmer switch 110.

A zero-crossing detector 220 determines the zero-crossings of the input AC waveform from the AC power supply 102. A zero-crossing is defined as the time at which the AC supply voltage transitions from positive to negative polarity, or from negative to positive polarity, at the beginning of each half-cycle. The zero-crossing information is provided as an input to controller 214. The controller 214 provides the control inputs to the drive circuit 212 to operate the controllably conductive device 210 (i.e., to provide voltage from the AC power supply 102 to the lighting load 104) at predetermined times relative to the zero-crossing points of the AC waveform.

The dimmer switch 110 further comprises an RF receiver 222 and an antenna 224 for receiving the RF signals 106 from the remote control 120. The controller 214 is operable to control the controllably conductive device 210 in response to the messages received via the RF signals 106. Examples of the antenna 224 for wall-mounted dimmer switches, such as the dimmer switch 110, are described in greater detail in U.S. Pat. No. 5,982,103, issued Nov. 9, 1999, and U.S. patent application Ser. No. 10/873,033, filed Jun. 21, 2004, both entitled COMPACT RADIO FREQUENCY TRANSMITTING AND RECEIVING ANTENNA AND CONTROL DEVICE EMPLOYING SAME. The entire disclosures of both are hereby incorporated by reference.

FIG. 2B is a simplified block diagram of the remote control 120. The remote control 120 comprises a controller 230, which is operable to receive inputs from the on button 122, the preset button 124, and the off button 126. The remote control 120 further comprises a memory 232 for storage of the serial number, i.e., a unique identifier, of the remote control. Preferably, the serial number comprises a seven-byte number that is programmed into the memory 232 during manufacture of the remote control 120. A battery 234 provides a DC voltage V_{BATT} for powering the controller 230, the memory 232, and other low-voltage circuitry of the remote control 120.

The remote control 120 further includes an RF transmitter 236 coupled to the controller 230 and an antenna 238, which may comprise, for example, a loop antenna. In response to an actuation of one of the on button 122, the preset button 124, and the off button 126, the controller 230 causes the RF transmitter 236 to transmit a message to the dimmer switch 110 via the RF signals 106. Each transmitted message comprises the serial number of the remote control 120, which is stored in the memory 232, and a command indicative as to which of the three buttons was pressed (i.e., on, off, or preset).

According to the present invention, the lighting control system 100 provides a simple one-step configuration procedure for associating the remote control 120 with the dimmer switch 110. A user simultaneously presses and holds the on button 122 on the remote control 120 and the toggle button 114 on the dimmer switch 110 to link the remote control 120 and the dimmer switch 110. The user may simultaneously press and hold the off button 126 on the remote control 120 and the toggle button 114 on the dimmer switch 110 to unassociate the remote control 120 with the dimmer switch 110. Further, the user may simultaneously press and hold the preset button 124 on the remote control 120 and the toggle button 114 on the dimmer switch 110 to store the present intensity of the lighting load 104 as the preset intensity level.

The lighting control system may comprise a plurality of remote controls 120 that can all be associated with one dimmer switch 110, such that the dimmer switch is responsive to presses of the buttons 122, 124, 126 of any of the plurality of remote controls. The user simply needs to repeat the association procedure of the present invention for each of the plurality of remote controls 120. Preferably, up to eight remote controls 120 may be associated with one dimmer switch 110.

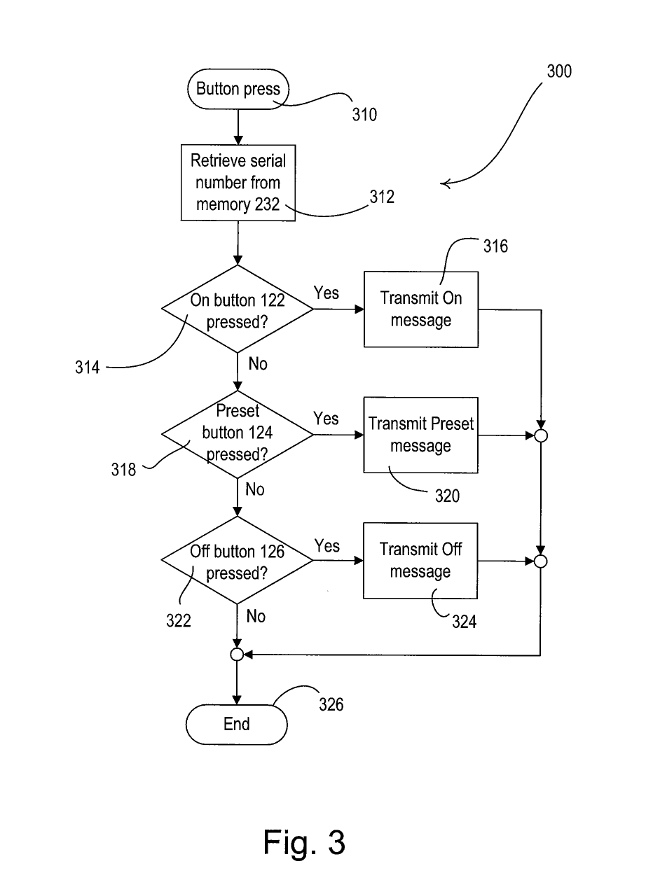

FIG. 3 is a flowchart of a button procedure 300 executed by the controller 230 of the remote control 120. The button procedure 300 is preferably executed when one of the buttons 122, 124, 126 is pressed at step 310. First, the serial number of the remote control 120 is retrieved from the memory 232 at step 312, such that the serial number can be transmitted in the message to the dimmer switch 110. If the on button 122 is pressed at step 314, an on message is transmitted, i.e., the message is transmitted with an on command, at step 316 and the procedure 300 exits at step 326. Similarly, if the preset button is pressed at step 318 or the off button is pressed at step 322, a preset message is transmitted at step 320 or an off message is transmitted at step 324, respectively, before the procedure 300 exits at step 326.

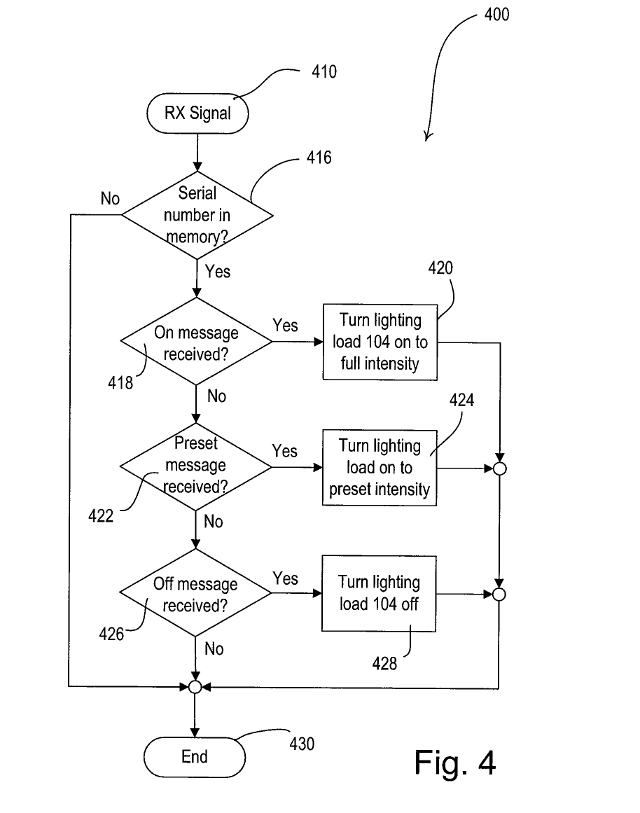

FIG. 4 is a flowchart of an RF signal procedure 400 executed by the controller 214 of the dimmer switch 110. The RF signal procedure 400 is interrupt-driven, i.e., the procedure 400 is executed when an RF signal is received at step 410. If the serial number contained in the received RF signal is not stored in the memory 232 at step 416, the procedure 400 simply exits at step 430. If the controller 214 has received an RF signal at step 414 and if the serial number contained in the received RF signal is stored in the memory 232 at step 416, a determination is made as to what type of command has been received at steps 418, 422, and 426. If an on message is received at step 418, the lighting load 104 is turned on to full intensity at step 420 and the procedure 400 exits at step 430. If a preset message is received at step 422, the lighting load 104 is turned on to the preset intensity level at step 424 and the procedure 400 exits at step 430. If an off message is received at step 426, the lighting load 104 is turned off at step 428 and the procedure 400 exits at step 430.

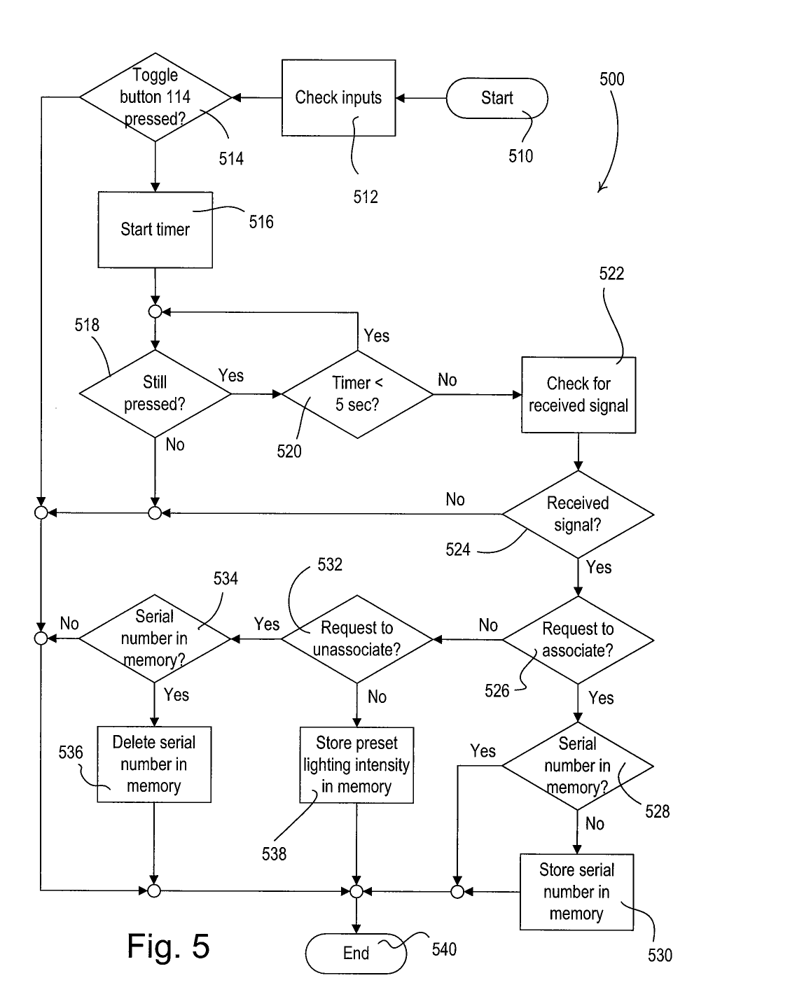

FIG. 5 is a flowchart of an association procedure 500 executed by the controller 214 of the dimmer switch 110 according to the present invention. The association procedure 500 begins at step 510. At step 512, the controller 214 checks the inputs from the toggle actuator 114 and the intensity adjustment actuator 116. If the toggle button 114 is pressed at step 514, a timer is started at step 516. The timer is used to determine how long the toggle button 114 is pressed. If the toggle button is still being pressed at step 518, a determination is made as to whether the timer is less than a predetermined time, e.g., five (5) seconds, at step 520. The association procedure 500 loops until either the toggle button 114 is released at step 518 (at which time the association procedure exits at step 534) or the timer has exceeded the predetermined time at step 520.

If the toggle button 114 is still pressed at step 518 and the timer is greater than the predetermined time at step 520, the controller checks for a received RF signal at step 522. If a signal has been received at step 524, a determination is made at step 526 as to whether the command of the received message is an on message (i.e., a request to associate the transmitting remote control 120 with the dimmer switch 110 by adding the serial number of the remote control 120 to the memory 216 of the dimmer switch). If the received message is a request to associate the remote control 120 with the dimmer switch 110 at step 526 and the serial number from the received message is not already stored in the memory at step 528, the serial number is stored in the memory at step 530 and the association procedure 500 exits at step 540. If the received message is a request to associate the remote control 120 with the dimmer switch 110 at step 526, but the serial number is already stored in the memory at step 528, the association procedure 500 simply exits at step 540.

If the received message is an off message (i.e., a request to unassociate the transmitting remote control 120 with the dimmer switch 110 by deleting the serial number of the remote control 120 from the memory 216) at step 532 rather than an on message at step 526, a determination is made at step 534 as to whether the serial number from the received message is stored in memory. If so, the serial number is deleted from the memory at step 536, and the association procedure 500 exits at step 540. Otherwise, the association procedure 500 simply exits at step 540. If the received message is a preset message (i.e., not an off message) at step 532, the present intensity level is stored in memory as the preset intensity level at step 538 and the association procedure 500 exits at step 540.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A lighting control system comprising:
a remotely-controllable load control device adapted to be disposed in an electrical wall-box and connectable to an electrical power system for providing electrical power to an electrical load, the remotely controllable load control device comprising:
a controllably conductive device for switching electrical power to the load;
a first controller for controlling a conducting state of the controllably conductive device;
a first actuator coupled to the first controller; and
a wireless signal receiver coupled to the first controller for providing a first control signal to the controller, whereby the first controller controls the controllably conductive device in response to one of the first control signal and an actuation of the first actuator;
a remote transmitting device for transmitting a wireless control signal to the wireless signal receiver for controlling the supply of electrical power to the load from a remote location, the remote transmitting device comprising:
a second controller operable to generate the wireless control signal, the wireless control signal including a unique identifier that uniquely identifies the remote transmitting device;
a second actuator coupled to the second controller; and
a wireless signal transmitter coupled to the second controller for transmitting the wireless control signal to the first controller of the remotely-controllable load control device in response to an actuation of the second actuator;
wherein the remotely-controllable load control device is operable to associate the identifier includes in the wireless control signal with the remotely-controllable load control device in response to simultaneous actuations of the first and second actuators for a predetermined amount of time, thereby to enable control of the controllably conductive device from the remote transmitting device.

2. The lighting control system of claim 1, further wherein the first controller comprises a microprocessor.

3. The lighting control system of claim 2, further wherein the second controller comprises a microprocessor.

4. The lighting control system of claim 2, wherein the remotely-controllable load control device further comprises a memory operable to store the identifier.

5. The lighting control system of claim 1, wherein the load is a lighting load and the controllably conductive device controls an intensity of the lighting load.

6. The lighting control system of claim 1, wherein the wireless control signal comprises a radio-frequency (RF) signal, and the remotely-controllable load control device further comprises a radio-frequency (RF) antenna coupled to the wireless signal receiver to receive the RF signal.

7. The lighting control system of claim 1, wherein the wireless control signal comprises an infrared (IR) signal and the wireless signal receiver comprises an infrared (IR) receiver.

8. The lighting control system of claim 1, further comprising a memory, wherein the unique identifier comprises a serial number associated with the remote transmitting device, the unique identifier stored in the memory.

9. The lighting control system of claim 1, wherein the remotely-controllable load control device comprises a second wireless transmitter, and the remote transmitting device comprises a second wireless receiver for enabling two-way communication between the remotely-controllable load control device and the remote transmitting device.

10. The lighting control system of claim 1, wherein the remote transmitting device transmits a command to the remotely-controllable load control device in addition to the unique identifier to control the conducting state of the controllably conductive device.

11. The lighting control system of claim 10, wherein the command comprises an on command, an off command, or a preset command.

12. The lighting control system of claim 10, wherein the first controller is operable to determine whether the remotely-controllable load control device should control the conducting state of the controllably conductive device in response to the command.

13. The lighting control system of claim 1, further comprising a second remote transmitting device for providing a second wireless control signal to the wireless signal receiver for controlling the conducting state of the controllably conductive device from a second remote location.

14. The lighting control system of claim 13, wherein the second remote transmitting device transmits a second unique identifier, and the first controller of the remotely-controllable load control device is operable to associate the second unique identifier from the second remote transmitting device with the remotely-controllable load control device.

15. A wireless lighting control system for controlling the amount of power delivered to an electrical load from an AC power source, the wireless lighting control system comprising:
a load control device operable to be coupled in series electrical connection between the source and the load for controlling the amount of power delivered to the load, the load control device comprising a first actuator and a wireless receiver, such that the load control device is operable to control the amount of power delivered to the load in response to an actuation of the first actuator and a wireless control signal received by the wireless receiver; and
a remote control comprising a second actuator and a wireless transmitter, the wireless transmitter operable to transmit the wireless control signal in response to an actuation of the second actuator;
wherein the remote control is associated with the load control device in response to simultaneous actuations of the first and second actuators, such that the load control device is operable to control the amount of power delivered to the load in response to the wireless control signal transmitted by the wireless transmitter of the remote control.

16. A load control device for controlling the amount of power delivered to an electrical load from an AC power source, the load control device comprising:
a controllably conductive device operable to be coupled in series electrical connection between the source and the load for controlling the amount of power delivered to the load, the controllably conductive device having a control input for controlling the controllably conductive device between a conductive state and a non-conductive state;
a controller coupled to the control input for controlling the controllably conductive device;
an actuator coupled to the controller, such that the controller is operable to detect that the actuator has been actuated for a predetermined amount of time;
a wireless receiver coupled to the controller and operable to receive a wireless control signal from a remote control, the wireless control signal comprising a unique identifier associated with the remote control; and
a memory coupled to the controller, wherein the controller is operable to store the unique identifier in the memory when the controller has detected that the actuator has been actuated for the predetermined amount of time.

17. A method of controlling a dimmer switch from a remote control in a wireless lighting control system, the dimmer switch operable to control the amount of power delivered to an electrical load from an AC power source, the method comprising the steps of:
simultaneously actuating a first actuator on the dimmer switch and a second actuator on the remote control for a predetermined amount of time; and
storing a serial number associated with the remote control at the dimmer switch to associate the remote control with the dimmer switch.

18. The method of claim 17, wherein the step of storing a serial number comprises storing the serial number in a memory of the dimmer switch.

19. The method of claim 18, further comprising the steps of:
simultaneously actuating the first actuator on the dimmer switch and a third actuator on the remote control for a second predetermined amount of time; and
deleting the serial number of the remote control from the memory of the dimmer switch to unassociate the remote control from the dimmer switch.

20. The method of claim 18, further comprising the steps of:
adjusting the amount of power delivered to the electrical load by the dimmer switch to a preset level;
simultaneously actuating the first actuator on the dimmer switch and a third actuator on the remote control for a second predetermined amount of time; and
storing the preset level in memory.

21. The method of claim 17, further comprising the step of:
controlling the amount of power delivered to the lighting load in response to an actuation of the second actuator of the remote control.

22. A method of associating a remote control with a dimmer switch in a wireless lighting control system, the method comprising the steps of:
simultaneously actuating a first actuator on the dimmer switch and a second actuator on the remote control for a predetermined amount of time; and
storing a serial number of the remote control at the dimmer switch in response to the step of simultaneously actuating.

23. The method of claim 22, wherein the step of storing a serial number comprises storing the serial number in a memory of the dimmer switch.

24. The method of claim 22, wherein the step of simultaneously actuating comprises simultaneously pressing and holding the first actuator on the dimmer switch and the second actuator on the remote control for the predetermined amount of time.

25. The method of claim 22, wherein the predetermined amount of time is five seconds.
